(19) United States
(12) Patent Application Publication
(10) Pub. No.: US 2017/0126886 A1
(43) Pub. Date: May 4, 2017

(54) System For Direct Control By The Caller Of The On-Hold Experience.

(71) Applicant: MusicRogue, Rancho Cordova, CA (US)

(72) Inventors: Joel Nathan Shapiro, Rancho Cordova, CA (US); Jason Wells Davies, Sacramento, CA (US)

(73) Assignee: MusicRogue, Rancho Cordova, CA (US)

(21) Appl. No.: 15/295,469

(22) Filed: Oct. 17, 2016

Related U.S. Application Data
(60) Provisional application No. 62/248,971, filed on Oct. 30, 2015.

(51) Int. Cl. H04M 3/428; H04M 1/725

(52) U.S. Cl. CPC H04M 3/4286; H04M 1/72525; H04M 3/4285

(57) ABSTRACT

Calling parties are provided a system which supplants and replaces their on hold phone signal sent by the phone call receiving party. The on hold signal is monitored and controlled. During the holding time the calling party is allowed to use their own phone to pursue other tasks. Upon its termination the calling party is returned to the phone call.

### CROSS-REFERENCE TO RELATED APPLICATIONS.

This application claims priority to an earlier-filed provisional application #62248971. EFS ID #23950562.

### STATEMENT REGARDING FEDERALLY SPONSORED RESEARCH OR DEVELOPMENT.

None

### THE NAMES OF THE PARTIES TO A JOINT RESEARCH AGREEMENT.

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE §1.52(E)(5)). THE TOTAL NUMBER OF COMPACT DISCS INCLUDING DUPLICATES AND THE FILES ON EACH COMPACT DISC SHALL BE SPECIFIED.

Not Applicable

### STATEMENT REGARDING PRIOR DISCLOSURES BY THE INVENTOR OR A JOINT INVENTOR.

Not currently aware of relevant prior disclosures.

### BACKGROUND OF THE INVENTION.

1. Field of the Invention

The general field of the invention is telecommunication. The invention relates to systems and methods for giving caller the ability to control their on-hold experience without regard to the party placing the caller on-hold

2. Background

Placing a call to a business or a government agency can lead to lengthy on hold times. When the receiving party (party receiving the call) does not have enough operators to answer the phone, is busy, or just chooses to do so, the caller is placed “on hold” whereby a signal controlled by the receiving party is sent to the calling party (party making the call), placing the calling party in a holding pattern. Being on hold is often frustrating. There is no way to know the hold time and there is little the caller can do while they wait. Focusing your attention on something else greatly risks missing the call being finally picked up. As a result, callers are subjected to an unpleasant and boring experience.

This is a problem for both the receiving and calling party. The calling party does not want to waste time. They also do not want to hang up and lose their place in line or miss the return call. The receiving party in these cases is usually concerned with the caller experience and would like to make it more pleasing. Until now there has been no real solution to this issue. The traditional approach has been playing preselected music through the phone connection. Due to the nature of a phone connection this results in both low quality sound, and possible an even greater annoyance to the caller as they did not select the music. Newer approaches have focused on trying to provide the caller more options such as different radio stations or news through the phones touch dial. All of these approaches suffer from many flaws. The main source of the flaws being that they are provided by the receiving party through the phone connection. This results in a poor quality signal, limited options, and places the caller at the mercy of the receiving party to have any on hold options at all.

### BRIEF SUMMARY OF THE INVENTION

This invention solves the aforementioned problems by placing the control of the on hold experience with the calling party instead of the receiving party. This invention provides systems and methods by which the calling party shall be able to use their phone to override the on-hold signal of the receiving party and return to the call once the on-hold signal terminates. During the interim period, the receiving party shall be able to do various tasks on their phone including streaming music, accessing files on the phone, and using other applications. An embodiment of the invention will be a downloadable app which upon activation will produce a button in the phone's dialer. Once the Calling Party is placed on hold, they will press said button to activate the invention and override the on-hold signal. The calling party shall then be able to use the app to do various tasks on their phone, such as playing music of their choice or pursue other activities on the phone or elsewhere knowing they will be connected with the receiving party the moment they are no longer on-hold.

### BRIEF DESCRIPTION OF THE SEVERAL VIEWS OF THE DRAWING

FIG. 1 Illustrates, in general block diagraph form, the phone call process through which the invention is most likely to be used.

FIG. 2 Illustrates, in general block diagraph form, and embodiment of the calling party experience of using the invention.

FIG. 3 Illustrates three possible embodiments of the invention

### DETAILED DESCRIPTION OF THE INVENTION

Referring to the figures a few embodiments of the invention will be described.

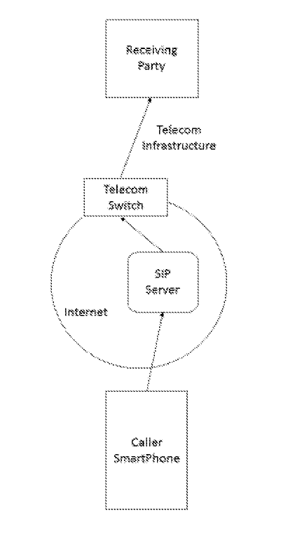

FIG. 1 demonstrates the general process of making a telephone call using the Invention. Once the calling party has installed the invention on their telephone device they can use it to make phone calls. The embodiment shown in FIG. 1 will allow the calling party to place Voice Over IP calls using their smart-phone. The call is directed via the internet, either through WiFi, LTE, 4G, or 3G Data Connection of the user's provider, to the Invention's SIP Server. As other types of data connections become available, they may be utilized by the invention. Next, the invention's SIP Server will route the call to a telecom switch at a telecom provider over the Internet. The telecom switch will convert the call to the appropriate format and routes the call to the number called over existing telecom infrastructure.

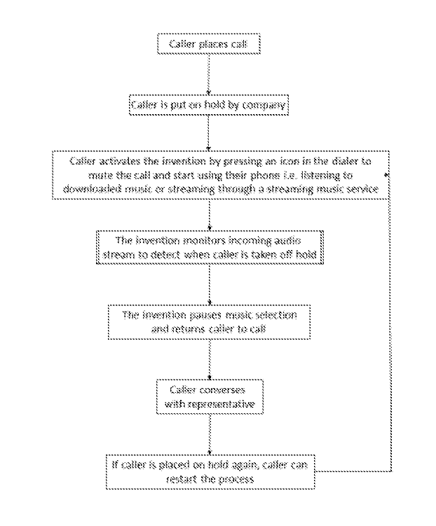

FIG. 2 demonstrates the basic functionality of the Invention as it will be experienced by the User, or calling party.

FIG. 2 demonstrates an embodiment of the user experience of using the Invention. The experience starts at the top of the image:
i. The calling party will make a phone call using a phone application on their internet enabled phone.
ii. The calling party is placed on hold.
iii. Once the calling party is placed on hold they activate the invention, which blocks the on hold signal and allows the calling party to use their phone in a multitude of ways, including listening to downloaded music files, streaming online content, or ignoring the call altogether.
iv. The invention monitors the incoming audio signal and detects when the user is taken of hold.
v. Once the invention detects the user has been taken off hold, it returns the calling party to the call.
vi. Calling party can then converse with the receiving party
vii. If the calling party is placed on hold again, they can activate the invention again.

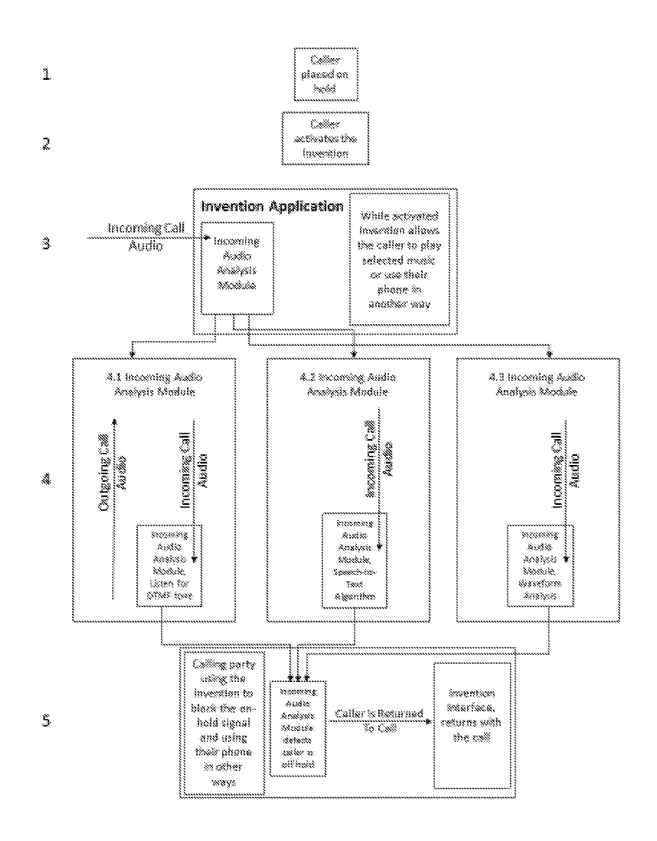

FIG. 3 illustrates 3 possible embodiments of the invention in 5 steps. In step 1 the calling party is placed on hold after making the call. In step 2 the calling party activated the invention. In step 3, the invention activates an incoming audio analysis module while allowing the calling party to use their phone to conduct activities such as play downloaded or streaming music or anything else their phone can do. Step 4 shows three different possible methods of audio analysis which the invention could use to determine when the calling party is no longer on hold. The methods could be used together, individually or in any mix in addition to other possible methods. In 4.1 the invention broadcasts a message to the receiving party to press a key. The audio analysis module listens for a Dual Tone Multi Frequency (DTMF) tone which is created when the receiving party presses any key on their phone. The occurrence of such tone would indicate the calling party is no longer on hold. In 4.2 the audio analysis module uses a speech to text algorithm to listen for the occurrence of human speech. The occurrence of such speech would indicate the calling party is no longer on hold. In 4.3 the audio analysis module analyzes the incoming sounds using Waveform analysis. The occurrence of a sudden change or certain patterns would indicate the calling party is no longer on hold. In step 5, once the audio analysis module has determined the user is no longer on hold, the invention curtails the calling parties activities on the phone, unblocks the receiving parties audio and returns the calling party to the phone call.

What is claimed is:

1. A method for supplanting a communication on hold signal, the method comprising:
An application installed on the calling party's communication device which blocks the incoming on hold signal,
And an analyzing module to which the on hold signal is passed and which analyzes the signal from the receiving party,
Once the analyzing module determines the calling party is no longer on hold, it restores the receiving party signal, returning the calling party to the call.

2. The method of claim 1 wherein the calling party may use their communication device through the invention interface.

3. The method of claim 1 wherein the calling party may use their communication device through the invention's interface which provides selectable options.

4. The method of claim 1 wherein the calling party may use their communication device directly without the use of the invention portal.

5. The methods of claim 1 wherein the calling party utilizes the invention to listen to music through the communication device.

6. The methods of claim 2 wherein the calling party utilizes the invention to listen to music through the communication device.

7. The methods of claim 3 wherein the calling party utilizes the invention to listen to music through the communication device.

8. The methods of claims 4 wherein the calling party utilizes the invention to listen to music through the communication device.
